(19) United States
(12) Patent Application Publication
(10) Pub. No.: US 2019/0180698 A1
(43) Pub. Date: Jun. 13, 2019

(54) METHOD FOR DRIVING BACKLIGHT MODULE, DRIVING DEVICE, DISPLAY APPARATUS AND BACKLIGHT MODULE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Qibing GU, Beijing (CN); Bo GAO, Beijing (CN); Wei SUN, Beijing (CN); Lingyun SHI, Beijing (CN); Hao ZHANG, Beijing (CN); Guangquan WANG, Beijing (CN); Ming CHEN, Beijing (CN); Xue DONG, Beijing (CN)

(21) Appl. No.: 16/119,037

(22) Filed: Aug. 31, 2018

(30) Foreign Application Priority Data
Dec. 12, 2017 (CN) 201711319002.7

(51) Int. Cl. G09G 3/34; G09G 3/36

(52) U.S. Cl. CPC G09G 3/342; G09G 3/3677; G09G 2310/0297; G09G 2310/0213; G09G 2330/021

(57) ABSTRACT

A method for driving a backlight module, a driving device, a backlight module and a display apparatus are provided. The backlight module includes a plurality lines of point sources, and each line of point sources correspond to each line of pixel units in a display panel one by one. The method includes: generating a first enable signal after a first time delay elapses from a time instant that a line scan of at least one line of pixel units for a first image frame of the display panel is completed; and driving point sources corresponding to the at least one line of pixel units specified to be turned on based on the first enable signal.

### CROSS-REFERENCE TO RELATED APPLICATIONS

The present application claims the priority to the Chinese Patent Application No. 201711319002.7, filed on Dec. 12, 2017, to the Chinese Intellectual Property Office, the contents of which are incorporated herein in their entirety by reference.

### TECHNICAL FIELD

The present disclosure relates to the field of display technology, and in particular to a method for driving a backlight module, a driving device, a display apparatus and a backlight module.

### BACKGROUND

With the development of a display panel, display technology regarding AR/VR/TV/MNT with high resolution and the like is improving, and requirements for brightness and contrast is becoming higher and higher. A traditional LCD module is disadvantageous in working stability and brightness, and is advantageous in cost, power consumption and productivity. In a close-range AR&VR display product, in order to prevent vertigo caused by deflection of liquid crystal molecules, black frame insertion technology is used and this technology requires that a backlight has a very high instantaneous brightness, and since the backlight has been in a turned-on state, a pixel region directly illuminated by the backlight has a too large working current, while a pixel region not directly illuminated by the backlight has a too small working current, resulting in backlight smear.

### SUMMARY

The present disclosure provides a method for driving a backlight module, a driving device, a display apparatus and a backlight module.

The present disclosure provides a method for driving a backlight module, the backlight module includes a plurality of lines of point sources, which correspond to a plurality of lines of pixel units in a display panel one by one, and the method includes: generating a first enable signal after a first time delay elapses from a time instant that a line scan of at least one line of pixel units for a first image frame of the display panel is completed; and driving point sources corresponding to the at least one line of pixel units to be turned on based on the first enable signal.

In an embodiment, the first time delay is a time required by the at least one line of pixel units to complete deflection of liquid crystal molecules.

In an embodiment, the at least one line of pixel units include one line of pixel units, the plurality of lines of pixel units are scanned line by line, and the method includes: generating the first enable signal after the first time delay elapses from a time instant that a line scan of the one line of pixel units for the first image frame of the display panel is completed; driving point sources corresponding to the one line of pixel units to be turned on based on the first enable signal; generating a second enable signal after the first time delay elapses from a time instant that a line scan of a next line of pixel units is completed; and driving point sources corresponding to the next line of pixel units to be turned on based on the second enable signal.

In an embodiment, the at least one line of pixel units include two adjacent lines of pixel units, the plurality of lines of pixel units are scanned line by line, and the method includes: generating the first enable signal after the first time delay elapses from a time instant that a line scan of the two adjacent lines of pixel units for the first image frame of the display panel is completed; driving two lines of point sources corresponding to the two adjacent lines of pixel units to be turned on based on the first enable signal; generating the second enable signal after the first time delay elapses from a time instant that a line scan of next two adjacent lines of pixel units is completed; and driving two lines of point sources corresponding to the next two adjacent lines of pixel units to be turned on based on the second enable signal.

In an embodiment, the method further includes starting a line scan of the at least one line of pixel units for a second image frame of the display panel after the point sources corresponding to the at least one line of pixel units are turned off, the first and second image frames being two continuous image frames.

The present disclosure further provides a driving device for driving a backlight module which includes a plurality lines of point sources, the plurality lines of point sources corresponding to a plurality of lines of pixel units in a display panel one by one, wherein the driving device includes: a controller, configured for generating and outputting a first enable signal after a first time delay elapses from a time instant that a line scan of at least one line of pixel units for a first image frame of the display panel is completed; and a driver, configured for driving point sources corresponding to the at least one line of pixel units to be turned on based on the first enable signal.

In an embodiment, the first time delay is a time required by the at least one line of pixel units to complete deflection of liquid crystal molecules.

In an embodiment, the at least one line of pixel units include one line of pixel units; the controller is further configured for scanning the plurality of lines of pixel units line by line, generating and outputting the first enable signal after the first time delay elapses from a time instant that a line scan of the one line of pixel units for the first image frame of the display panel is completed, and generating and outputting a second enable signal after the first time delay elapses from a time instant that a line scan of a next line of pixel units is completed; and the driver is configured for driving point sources corresponding to the one line of pixel units to be turned on based on the first enable signal and driving point sources corresponding to the next line of pixel units to be turned on based on the second enable signal.

In an embodiment, the at least one line of pixel units include two adjacent lines of pixel units; the controller is further configured for scanning the plurality of lines of pixel units line by line, generating and outputting the first enable signal after the first time delay elapses from a time instant that a line scan of the two adjacent lines of pixel units for the first image frame of the display panel is completed, and generating and outputting the second enable signal after the first time delay elapses from a time instant that a line scan of next two adjacent lines of pixel units is completed; and the driver is configured for driving point sources corresponding to the two adjacent lines of pixel units to be turned on based on the first enable signal and driving point sources corresponding to the next two adjacent lines of pixel units to be turned on based on the second enable signal.

In an embodiment, the controller is further configured for starting a line scan of the at least one line of pixel units for a second image frame of the display panel after the point sources corresponding to the at least one line of pixel units are turned off, the first and second image frames being two continuous image frames.

The present disclosure further provides a backlight module, which includes the above driving device and a light source.

The present disclosure further provides a display apparatus, which includes a display panel and the above backlight module.

### BRIEF DESCRIPTION OF THE DRAWINGS

Drawings are provided to make a person skilled in the art better understand the present disclosure, and constitute a part of the description. The drawings are used to interpret the present disclosure together with embodiments of the present disclosure, and will not limit the present disclosure.

FIG. 1a is a schematic view illustrating a relationship between a plurality of lines of pixel units in a display panel and a plurality of lines of point sources in a backlight module according to an embodiment of the present disclosure;

FIG. 1b is a flowchart illustrating a method for driving a backlight module according to an embodiment of the present disclosure;

FIG. 2 is a flowchart illustrating a method for driving a backlight module according to an embodiment of the present disclosure;

FIG. 3 is a schematic diagram illustrating pulse signals of the method for driving a backlight module according to an embodiment in the present disclosure;

FIG. 4 is a block diagram illustrating a structure of a driving device according to an embodiment of the present disclosure;

FIG. 5 is a schematic diagram illustrating a circuit structure of a driver included in the driving device of the present disclosure;

FIG. 6 is a schematic diagram illustrating connection between five 1:4 MUX driving ICs and twenty lines of point sources; and

FIG. 7 is a schematic view illustrating pulse signals output by the driver of the present disclosure.

### DETAILED DESCRIPTION

In order to make a person skilled in the art better understands the technical solution in the present disclosure, the specific implementations of the present disclosure will be described in detail below in conjunction with the drawings.

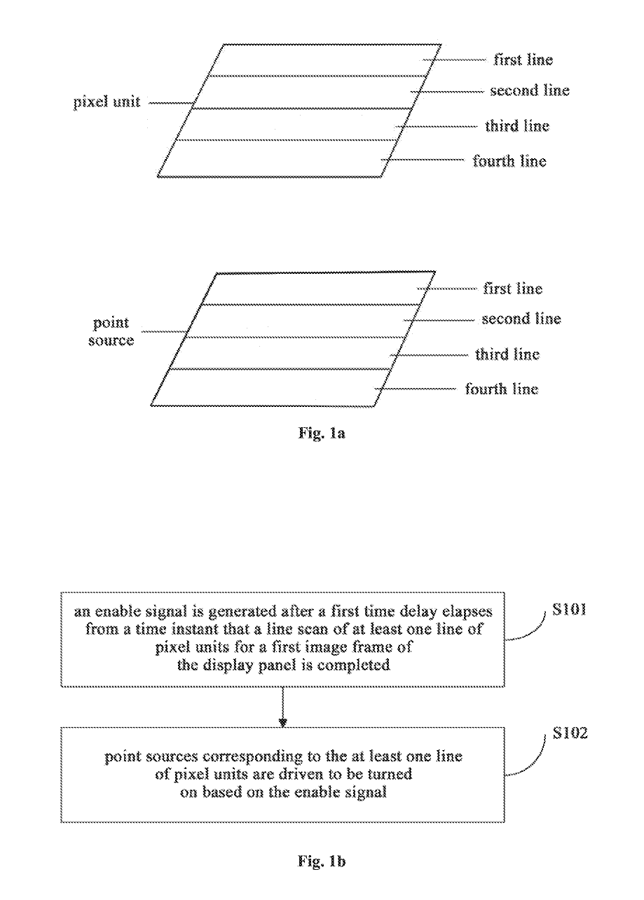

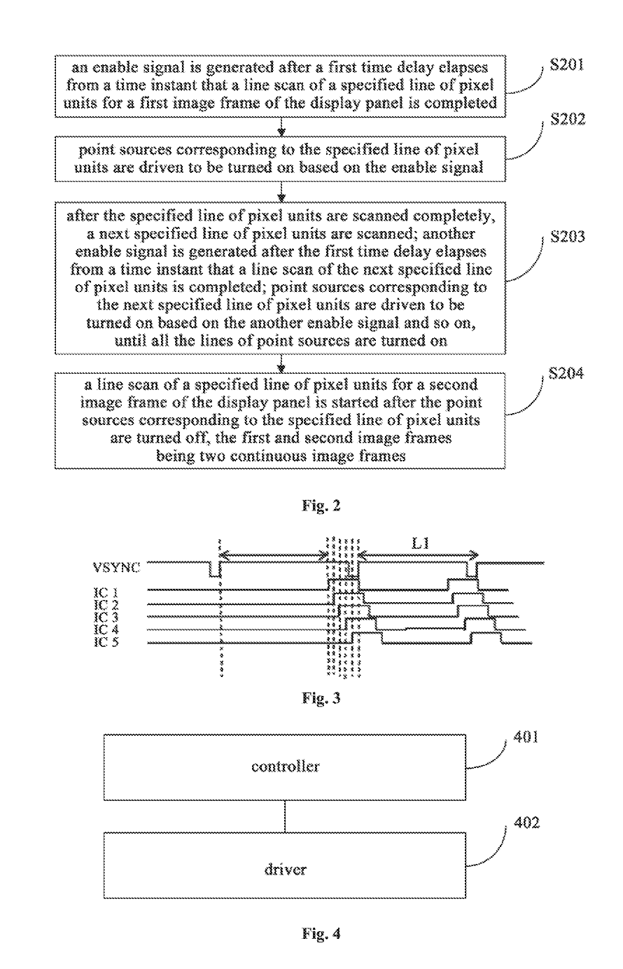

Referring to FIG. 1b, a flowchart illustrating a method for driving a backlight module according to an embodiment of the present disclosure is shown. The backlight module includes a plurality of lines of point sources, which correspond to a plurality of lines of pixel units in a display panel. For example, the plurality of lines of point sources correspond to the plurality of lines of pixel units in a display panel one by one, as shown in FIG. 1a. FIG. 1a only illustrates an example of a relationship between the plurality of lines of pixel units and the plurality of lines of point sources, and the present disclosure is not limited herein.

The method for driving a backlight module includes steps 101 and 102.

At step 101, an enable signal is generated after a first time delay elapses from a time instant that a line scan of at least one line of pixel units for a first image frame of the display panel is completed.

The present disclosure is based on the principle regarding deflection of liquid crystal molecules. When the deflection of liquid crystal molecules is not completed, the point sources are in a closed state, and the enable signal is generated after a line scan of a specified number of lines of pixel units in the display panel for a first image frame is completed and the deflection of liquid crystal molecules in the display panel is completed.

The first time delay may be set based on a time required for completing the deflection of the liquid crystal molecules, or may be set in any other manner. For example, the first time delay may be set greater or slightly less than the response time required for the liquid crystal molecules to deflect, or the like. The present disclosure is not limited thereto. In a practical application, the first time delay may be 5 ms or 6 ms.

The specified number of lines of pixel units may be one line of pixel units, two adjacent lines of pixel units, or more than two lines of pixel units in the display panel.

At step S102, point sources corresponding to the at least one line of pixel units are driven to be turned on based on the enable signal.

The point source may be a light-emitting diode (LED), and the point source of the present disclosure is not limited thereto.

The present embodiment may be implemented by a driving IC for driving the backlight module, and the driving IC may be connected to a scan driver, such as a GOA driver. Optionally, the present embodiment may be implemented by a driving device separately added between the scan driver and the driving IC for driving the backlight module.

Taking the driving IC for driving the backlight module as an example, the steps 101 and 102 may be performed as follows. After a line scan of a line of pixel units driven by the scan driver is completed, a timer starts until the first time delay reaches, and then the enable signal is generated so that the driving IC is triggered to drive the point sources corresponding to the line of pixel units to be turned on.

It may also be possible that the timer starts at the beginning of the line scan driven by the scan driver. When the timing meets a time required for completing the line scan plus the first time delay, the enable signal is generated to trigger the driving IC to drive the point sources corresponding to the line of pixel units to be turned on.

It may also be possible that the scan driver triggers the driving IC to start timing after a line scan of a line of pixel units driven by the scan driver is completed. When the timing reaches the first time delay, the driving IC generates an enable signal to trigger the point sources corresponding to the line of pixel units to be turned on.

It may also be possible that the scan driver triggers the driving IC to start timing at the beginning of a line scan of a line of pixel units driven by the scan driver. When the timing meets a time required for completing line scan plus the first time delay, the driving IC generates an enable signal to trigger the point sources corresponding to the line of pixel units to be turned on.

The present disclosure is not limited to the above implementations as long as an enable signal is generated after the first time delay elapses from a time instant that line scan of the specified number of lines of pixel units is completed, and then the point sources corresponding to the specified number of lines of pixel units are driven to be turned on. In the prior art, a backlight with a constant brightness is always used. When the backlight with the constant brightness illuminates the respective lines of pixel units, the response times of the liquid crystal molecules in the respective lines of pixel units within a region covered by the backlight may be different due to the fact that the region is large. Thus, there are some pixel units whose liquid crystal molecules deflect finished and some pixel units whose liquid crystal molecules deflect uncompleted, and the working current of some pixel units is too large, and the working current of some other pixel units is too small, resulting in the phenomenon of backlight smear. In order to solve the problem of backlight smear, the present disclosure makes the point sources corresponding to the pixel units whose liquid crystal molecules deflect uncompleted in a closed state. After the liquid crystal molecules for the pixel units complete deflecting (that is, when the delay condition is satisfied), the line of point sources corresponding to the line of pixel units are driven to be turned on, thus avoiding the backlight smear.

In an embodiment of the present disclosure, after the above steps S101 and 5102 have been performed, the following steps S210 to S204 may be further performed until each line of pixel units are scanned and each line of point sources are turned on. That is, the first image frame is displayed completely.

At step S201, an enable signal is generated after a first time delay elapses from a time instant that a line scan of a specified line of pixel units for a first image frame of the display panel is completed.

At step S202, point sources corresponding to the specified line of pixel units are driven to turn on based on the enable signal.

At step S203, after the specified line of pixel units are scanned completely, a next specified line of pixel units are scanned; another enable signal is generated after the first time delay elapses from a time instant that a line scan of the next specified line of pixel units is completed; point sources corresponding to the next specified line of pixel units are driven to turn on based on the another enable signal; and so on until all the lines of point sources are turned on.

The first time delay may be a time required by the liquid crystal molecules to complete deflecting, that is, the response time of the liquid crystal molecules, or may be a time set according to actual requirements. The first time delay for the respective lines of pixel units may be the same.

In the case that the first time delay is satisfied, the point sources may be turned on line by line as follows. Note that the following is described in the case that the pixel units are scanned line by line.

After the first time delay elapses from the line scan of the first line of pixel units completed, the first line of point sources are turned on, and after the first time delay elapses from the line scan of the second line of pixel units completed, the second line of point sources are turned on. In this way, the respective lines of point sources are turned on line by line.

Optionally, in an embodiment of the present disclosure, taking a driving IC for a backlight module as an example, the driving IC may start timing immediately after receiving a frame synchronization signal VSYNC, trigger the enable signal to turn on the first line of point sources after the first time delay elapses once scanning the first line of pixel units is completed, and then trigger the enable signal to turn on the second line of point sources after the first time delay elapses once scanning the second line of pixel units is completed until all lines of point sources are turned on. If the scan time required for scanning each line of pixel units and the first time delay are determined, the scan time and the first time delay may be built into the driving IC. The driving IC may start timing after receiving the VSYNC and then turn on the respective lines of point sources line by line based on the built-in scan time and the first time delay.

In the above embodiment, one line of point sources are turned on at a time. In a practical application, two lines, even three lines, or more lines of point sources may be turned on at a time.

In the case that there are even numbers of lines of point sources, two lines of point sources are turned on at a time as follows. Note that the following is described in the case that the pixel units are scanned line by line.

After the first time delay elapses from the line scan of the first two lines of pixel units completed, the first two lines of point sources are turned on, and after the first time delay elapses from the line scan of the second two lines of pixel units completed, the second two lines of point sources are turned on. In this way, the respective lines of point sources are turned on in a manner of two lines at a time.

Optionally, in an embodiment of the present disclosure, still taking a driving IC for a backlight module as an example, the driving IC may start timing immediately after receiving a frame synchronization signal VSYNC, trigger the enable signal to turn on the first two lines of point sources after the first time delay elapses once scanning the first two lines of pixel units is completed, and then trigger the enable signal to turn on the second two lines of point sources after the first time delay elapses once scanning the second two lines of pixel units is completed until all lines of point sources are turned on. If the scan time required for scanning each line of pixel units and the first time delay are determined, the scan time and the first time delay may be built into the driving IC. The driving IC may start timing after receiving the VSYNC and then turn on the respective lines of point sources in a manner of two lines at a time based on the built-in scan time and the first time delay.

At step 204, a line scan of a specified line of pixel units for a second image frame of the display panel is started after the point sources corresponding to the specified line of pixel units are turned off, the first and second image frames being two continuous image frames.

Before scanning the specified line of pixel units for the second image frame of the display panel, the point sources corresponding to the specified line of pixel units is turned off line by line, thus ensuring that the point sources corresponding to the line of pixel units are turned off before the line of pixel units are scanned.

In the above example, the point source may be driven to be turned on by the enable signal of a pulse signal, which is controlled by a scan signal of the display panel. FIG. 3 shows a specific form of the pulse signal. The pulse signal at a first line in FIG. 3 is the frame synchronization signal VSYNC, which is a start signal for a image frame displayed by the LCD panel, and pulse signals at second to sixth lines represent time series in which the point sources of LED corresponding to a first driving IC to a fifth driving IC are driven, respectively. L1 represents one image frame. When the first driving IC starts timing for a first time delay, the point sources corresponding to the first line of pixel units are turned on. After a second time delay elapses, the point sources corresponding to the second line of pixels units are turned on by the second driving IC, and so on, until the point sources corresponding to the fifth line of pixel units are turned on, and thus the point sources are turned on line by line. In the example, the second line of point sources are turned on after the second time delay elapses from the time instant that the second line of point sources are turned on, and the third to fifth lines of point sources are turned on after the second time delay elapses from the time instant that the second to fourth lines of point sources are turned on, respectively. The second time delay is set based on the scan time required the scanning one line of pixel units, and the first time delay is set to be a time between the time instant that scanning the specified line of pixel units is completed and the time instant that the point sources corresponding to the specified line of pixel units are turned on.

In the embodiment of the present disclosure, the backlight module includes a plurality of lines of point sources, which correspond to a plurality of lines of pixel units in the display panel one by one, and an enable signal is generated after a first time delay elapses from a time instant that a line scan of a specified line of pixel units for a first image frame of the display panel is completed; and point sources corresponding to the specified line of pixel units are driven to be turned on based on the enable signal. In this way, each line of point sources are turned on or off by a time delay, the backlight smear may be avoided.

Second, the point source in the present disclosure does not continuously emit light, but only emits light after the deflection of the liquid crystal molecules is completed, thus reducing energy consumption of the backlight.

It should be noted that, for the sake of a simple description of embodiments of the foregoing method, the method is described as a combinations of a series of actions, but a person skilled in the art should be aware that the disclosure is not limited by the order of actions described, since certain steps may be performed in other sequences or simultaneously. Secondly, a person skilled in the art should also be aware that the embodiments described in the description are all exemplary embodiments and that the actions involved are not necessarily necessary for the disclosure.

Referring to FIG. 4, a block diagram of a driving device for driving a backlight module, which includes a plurality of lines of point sources corresponding to a plurality of pixel units in a display panel, is shown. The driving device includes a controller 401 configured for generating and outputting an enable signal after a first time delay elapses from a time instant that a line scan of at least one line of pixel units for a first image frame of the display panel is completed. For example, the controller 401 is configured for outputting the enable signal after a line scan of the at least one line of pixel units for the first image frame of the display panel is completed as well as liquid crystal molecules for the at least one of pixel units deflect completed.

The controller 401 is further configured for turning off the point sources corresponding to the at least one line of pixel units for a second image frame of the display panel before starting a line scan of the at least one line of pixel units, and the first and second image frames are two continuous image frames.

The driving device also includes a driver 402 configured for driving point sources corresponding to the at least one line of pixel units to be turned on based on the enable signal.

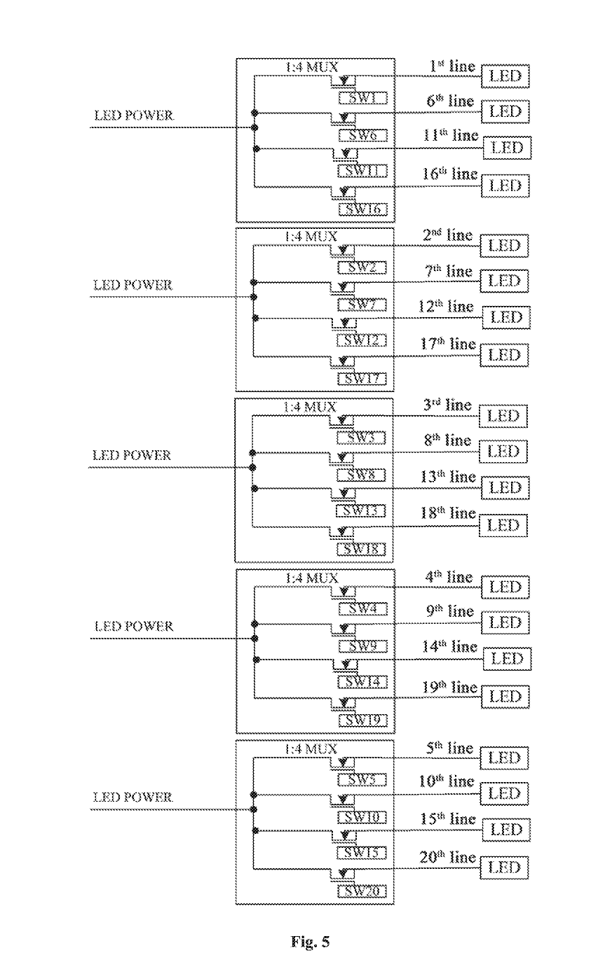

Referring to FIG. 5, a schematic diagram of a circuit structure of the driver 402 is shown.

For example, the backlight module includes twenty lines of point sources and five 1:4 MUX driving ICs. Each driving IC includes four controllers 401. Each controller 401 controls one line of point sources. The four lines of point sources connected to the four controllers 401 of each driving IC are set to be spaced from each other in the backlight module. The line numbers of the four lines of point sources in the backlight module connected to the four controllers 401 in each driving IC is arranged in an arithmetic progression, with a tolerance of 5.

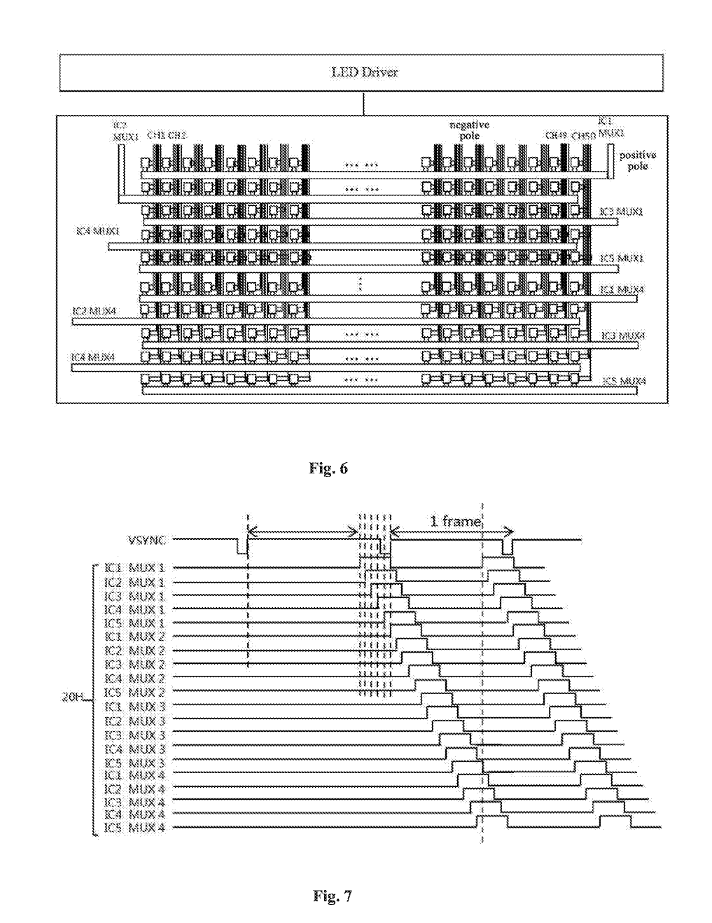

As shown in FIG. 6, a schematic diagram of a connection between five 1:4 MUX driving ICs and twenty lines of point sources is shown. Each driving IC includes four controllers, a positive pole of the point source is connected to the driving IC, and a negative pole of the point source is connected to one corresponding driving channel CH of fifty driving channels CH of the driving IC.

Referring to FIGS. 5 and 6, the first driving IC includes four controllers (SW1, SW6, SW11, SW16), which are connected to a first, sixth, eleventh and sixteenth lines of point sources, respectively. The second driving IC includes four controllers (SW2, SW7, SW12, SW17), which are connected to a second, seventh, twelfth and seventeenth lines of point sources, respectively. The third driving IC includes four controllers (SW3, SW8, SW13, SW18), which are connected to a third, eighth, thirteenth and eighteenth lines of point sources, respectively. The fourth driving IC includes four controllers (SW4, SW9, SW14, SW19), which are connected to a fourth, nineteenth, fourteenth and nineteenth lines of point sources, respectively. The fifth driving IC includes four controllers (SW5, SW10, SW15, SW20), which are connected to a fifth, tenth, fifteenth and twentieth lines of point sources, respectively.

In the above example, the point source may be driven to be turned on by a pulse signal output by the drive, and the pulse signal may be controlled by the scan signal of the display panel. FIG. 7 shows time series of voltage signals in pulse forms, which are supplied to the twenty lines of point sources by the five 1:4 MUX driving ICs. As shown in FIG. 7, a pulse signal at the first line is the frame synchronization signal VSYNC, which is a start signal for an image frame displayed by the LCD panel. Pulse signals at the second to sixth lines are time series of voltage signals supplied to the point sources corresponding to the first driving IC to the fifth driving IC, and 1 frame represents a image frame.

The first to fifth driving ICs drive the controllers SW1, SW2, SW3, SW4 and SW5 in the first to fifth driving ICs to be successively turned on based on the time series of voltage signals shown in FIG. 7 so that the first to fifth lines of point sources connected to the controllers SW1, SW2, SW3, SW4 and SW5 are successively turned on, and then after a during of the high-level signal (that is, the during of the pulse signal) preset by the driving IC, the controllers SW1, SW2, SW3, SW4 and SW5 are successively turned off and thus the first to fifth lines of point sources are successively turned off. Then, the sixth to tenth lines of point sources connected to the controllers SW6, SW7, SW8, SW9 and SW10 in the first to fifth driving IC are successively turned on, that is, when the controller SW1 is turned off, the controller SW6 is turned on; when the controller SW2 is turned off, the controller SW7 is turned on; when the controller SW3 is turned off, the controller SW8 is turned on; when the controller SW4 is turned off, the controller SW9 is turned on; when the controller SW5 is turned off, the controller SW10 is turned on, and so on, until all the twenty lines of point sources are turned on. That is, by controlling the five driving ICs, five lines of point sources may be successively turned on. For example, each driving IC may turn on point sources in two hundred partitions, and the five driving ICs may be reused to turn on point sources in one thousand partitions, thus reducing wiring of the driving IC and reducing the wire loss.

It should be noted that, this embodiment mainly introduces 1:4 MUX driving IC, and controls the driving ICs to turn on the different lines of point sources in an arithmetic progression. In a practical application, it is also possible to use a 1:6 MUX driving IC, a 1:8 MUX driving IC, or the like. The driving IC having proper number may be selected based on the number of the point sources, which is not limited in the present disclosure.

In the embodiment of the present disclosure, the backlight module includes a plurality of lines of point sources, which correspond to a plurality of lines of pixel units in the display panel one by one, and an enable signal is generated after a first time delay elapses from a time instant that a line scan of a specified line of pixel units for a first image frame of the display panel is completed; and point sources corresponding to the specified line of pixel units are driven to be turned on based on the enable signal. In this way, each line of point sources are turned on or off by a time delay, the backlight smear may be avoided.

In addition, the point source in the present disclosure does not continuously emit light, but only emits light after the deflection of the liquid crystal molecules is completed, thus reducing energy consumption of the backlight.

The present disclosure also discloses a backlight module including the driving device in the above embodiment.

The driving device has all the advantages of the driving device in the above embodiments, which will not be repeated any more.

The present disclosure also discloses a display apparatus including the backlight module of the above embodiment.

It should be noted that, the display apparatus in this embodiment may be any product or component having a display function such as a mobile phone, a tablet computer, a television, a notebook computer, a digital photo frame, a navigator.

The display apparatus has all the advantages of the backlight module in the above embodiments, which will not be repeated any more.

For the above-mentioned product embodiments, the description is relatively simple because they are basically similar to the method embodiments, and the relevant points can be referred to the method embodiments.

Each of the embodiments in this described is described in a progressive manner. Each of the embodiments highlights the difference from other embodiments. The same and similar parts of the respective embodiments can be learned from each other.

It is easily conceived by those skilled in the art to imagine that any combination of the above-mentioned embodiments is feasible, so any combination of the above-mentioned embodiments is an implementation of the present disclosure, which will not be described in detail here due to limit space.

It should be noted that, in this description, relational terms such as first and second are used only to distinguish one entity or operation from another entity or operation, without requiring or implying any such actual relationship or order between these entities or operations. Moreover, the terms “include” and “comprise” include not only those elements, but also other elements that are not explicitly listed, or elements inherent to such processes, methods, articles or equipment. Without any explicitly contrary statement, the phrase “including . . . ” does not exclude other element in the process, method, article or equipment.

Moreover, the term “and/or” indicates including both the “and” and the “or” relationships. That is, if the relationship between solution A and solution B is “and”, it means that both solution A and solution B may be included in an embodiment; and if the relationship between solution A and solution B is “or”, it represents an embodiment in which the solution may be included separately, or the solution B may be included separately.

Although certain embodiments of the present disclosure have been described, additional variants and modifications to these embodiments may be made once the basic creative concepts are known to those skilled in the art.

A method for driving a backlight module, a driving device, a backlight module and a display apparatus provided by the present disclosure are described in detail above. Specific examples are used to illustrate the principles and embodiments of the disclosure. The above description of the embodiments is only intended to help understand the methods and core ideas of the disclosure. It should be understood that, the above embodiments are only exemplary embodiments for the purpose of explaining the principle of the present disclosure, and the present disclosure is not limited thereto. For one of ordinary skill in the art, various variants and modifications may be made without departing from the spirit and essence of the present disclosure. These variants and modifications also fall within the protection scope of the present disclosure.

What is claimed is:

1. A method for driving a backlight module, wherein the backlight module comprises a plurality of lines of point sources, which correspond to a plurality of lines of pixel units in a display panel one by one, and the method comprises:
generating a first enable signal after a first time delay elapses from a time instant that a line scan of at least one line of pixel units for a first image frame of the display panel is completed; and
driving point sources corresponding to the at least one line of pixel units to be turned on based on the first enable signal.

2. The method of claim 1, wherein the first time delay is a time required for the at least one line of pixel units to complete deflection of liquid crystal molecules.

3. The method of claim 1, wherein the at least one line of pixel units comprise one line of pixel units, the plurality of lines of pixel units are scanned line by line, and the method comprises:
generating the first enable signal after the first time delay elapses from a time instant that a line scan of the one line of pixel units for the first image frame of the display panel is completed;
driving point sources corresponding to the one line of pixel units to be turned on based on the first enable signal;
generating a second enable signal after the first time delay elapses from a time instant that a line scan of a next line of pixel units is completed; and
driving point sources corresponding to the next line of pixel units to be turned on based on the second enable signal.

4. The method of claim 1, wherein the at least one line of pixel units comprise two adjacent lines of pixel units, the plurality of lines of pixel units are scanned line by line, and the method comprises:
generating the first enable signal after the first time delay elapses from a time instant that a line scan of the two adjacent lines of pixel units for the first image frame of the display panel is completed;
driving two lines of point sources corresponding to the two adjacent lines of pixel units to be turned on based on the first enable signal;
generating the second enable signal after the first time delay elapses from a time instant that a line scan of next two adjacent lines of pixel units is completed; and
driving two lines of point sources corresponding to the next two adjacent lines of pixel units to be turned on based on the second enable signal.

5. The method of claim 1, further comprising:
starting a line scan of the at least one line of pixel units for a second image frame of the display panel after the point sources corresponding to the at least one line of pixel units are turned off, the first and second image frames being two continuous image frames.

6. A driving device for driving a backlight module which comprises a plurality lines of point sources, the plurality lines of point sources corresponding to a plurality of lines of pixel units in a display panel one by one, wherein the driving device comprises:
a controller, configured for generating and outputting a first enable signal after a first time delay elapses from a time instant that a line scan of at least one line of pixel units for a first image frame of the display panel is completed; and
a driver, configured for driving point sources corresponding to the at least one line of pixel units to be turned on based on the first enable signal.

7. The driving device of claim 6, wherein the first time delay is a time required for the at least one line of pixel units to complete deflection of liquid crystal molecules.

8. The driving device of claim 6, wherein the at least one line of pixel units comprise one line of pixel units;
the controller is further configured for scanning the plurality of lines of pixel units line by line, generating and outputting the first enable signal after the first time delay elapses from a time instant that a line scan of the one line of pixel units for a first image frame of the display panel is completed, and generating and outputting a second enable signal after the first time delay elapses from a time instant that a line scan of a next line of pixel units is completed; and
the driver is configured for driving point sources corresponding to the one line of pixel units to be turned on based on the first enable signal and driving point sources corresponding to the next line of pixel units to be turned on based on the second enable signal.

9. The driving device of claim 6, wherein the at least one line of pixel units comprise two adjacent lines of pixel units;
the controller is further configured for scanning the plurality of lines of pixel units line by line, generating and outputting the first enable signal after the first time delay elapses from a time instant that a line scan of the two adjacent lines of pixel units for the first image frame of the display panel is completed, and generating and outputting the second enable signal after the first time delay elapses from a time instant that a line scan of next two adjacent lines of pixel units is completed; and
the driver is configured for driving point sources corresponding to the two adjacent lines of pixel units to be turned on based on the first enable signal and driving point sources corresponding to the next two adjacent lines of pixel units to be turned on based on the second enable signal.

10. The driving device of claim 6, wherein the controller is further configured for starting a line scan of the at least one line of pixel units for a second image frame of the display panel after the point sources corresponding to the at least one line of pixel units are turned off, the first and second image frames being two continuous image frames.

11. A backlight module, comprising a driving device and a light source, wherein the driving device is the driving device of claim 6.

12. A display apparatus, comprising a display panel and a backlight module, wherein the backlight module is the backlight module of claim 11.
